(19) United States
(12) Patent Application Publication
(10) Pub. No.: US 2016/0117745 A1
(43) Pub. Date: Apr. 28, 2016

(54) Method of personalization and securing hygiene of items in hotels and dorms

(71) Applicants: Jerry Mirsky, Owings Mills, MD (US); Boris Kokotov, Baltimore, MD (US); Irina Nossova, Baltimore, MD (US)

(72) Inventors: Jerry Mirsky, Owings Mills, MD (US); Boris Kokotov, Baltimore, MD (US); Irina Nossova, Baltimore, MD (US)

(21) Appl. No.: 14/523,933

(22) Filed: Oct. 26, 2014

(51) Int. Cl. G06Q 30/06; G06Q 50/12

(52) U.S. Cl. CPC G06Q 30/0621; G06Q 50/12

(57) ABSTRACT

The method of personalization, assigning individuality and securing hygiene of personal items in hotels, dorms and other places of guest accommodation by assigning a distinct feature or a combination of features to all items allotted to each individual in the same room. The feature may include a color, a shape, an ornament, a style, a texture, an embroidery, a pattern, a label or any other image being a part of the item or being attached to the item prior to distributing it to a guest.

Calculation of the number of arrays of distinct features equals to the number of guests in the hotel, dorm room. By this, each guest in the same room will receive a set of clearly identified personal items.

### BACKGROUND OF THE INVENTION

In most hotels, dorms and other places of guest accommodation personal disposable and non disposable items distributed to each guest are of identical shape and color and thus easy to mix up. Members of one family staying in the hotel room or guests unacquainted with each other use identical items in the room so that without an effort to separate the items, in few hours the items become mixed and hard to identify which item belongs to whom. It is very unpleasant and unhygienic to use towels, glasses, toothbrushes, shower caps, slippers, bathrobes that have already been used by another person. Most personal items in hotels and dorms are white looking all alike.

### DESCRIPTION OF THE INVENTION

Upon registration at the place of accommodation the guest shall receive a magnetic key card or a key charm that shall bear the same distinct feature as the rest of personal items to be used by this guest. In his hotel or dorm room the guest shall find that dishes, bedding, bed carpet, lampshade, towels, slippers, bathrobe, toothbrush, shower cap and other disposable and non disposable hygienic and domestic items meant for his personal use have the same distinctive feature. The feature may include the same color, shape, ornament, style, texture, embroidery, pattern, label or any other image being a part of the item or being attached to the item prior to distributing it to a quest.

The number of arrays of distinct features in one room is calculated according to the following formula: number of arrays of distinct features must be equal to number of guests in the hotel room. This shall guarantee that each guest will receive a set of clearly identified and individualized personal items in the room. In a room for two people the number of arrays shall be equal to two, meaning that the guest will find personal disposable and non disposable items of two different colors (or otherwise personified for each single guest) not to get them mixed with each other.

Application of this method should not pose difficulties to hotel administrations as the variety of personal items offered for purchase is extensive and allows for combination of arrays of distinct features at no additional cost. For example, instead of purchasing white bedding, towels, bathrobes etc the hotel can purchase items of different color (or otherwise personified) at the same price.

Finally, application of arrays of distinct features to personal items may enhance esthetical appearance and design of the hotel room by adding various and correlated colors, textures, ornaments etc. This shall allow for additional comfort making the hotel room more appealing to the guest.

We claim:

1. method of personalization of personal disposable and non disposable hygienic and domestic items, such as magnetic key cards, key chains, dishes, bedding, bed carpets, lampshades, towels, slippers, bathrobes, toothbrushes, shower caps in hotels, dorms and other places of guest accommodation by assigning a distinct feature or a combination of features to all items allotted to each individual in the same room.

2. The feature may include a color, a shape, an ornament, a style, a texture, an embroidery, a pattern, a label or any other image being a part of the item or being attached to the item prior to distributing it to a quest.

3. The number of arrays of distinct features must be equal to number of guests in the hotel room.

4. As an exception, the number of arrays of distinct features in a single bed hotel room may be equal to two arrays.
